(19) United States
(12) Patent Application Publication
(10) Pub. No.: US 2025/0046089 A1
(43) Pub. Date: Feb. 6, 2025

(54) AUTOMATIC RULE SETTING METHOD AND IMAGE CONTENT ANALYSIS APPARATUS

(71) Applicant: VIVOTEK INC., New Taipei City (TW)

(72) Inventor: Jen-Chih Wu, New Taipei City (TW)

(73) Assignee: VIVOTEK INC., New Taipei City (TW)

(21) Appl. No.: 18/792,572

(22) Filed: Aug. 2, 2024

(30) Foreign Application Priority Data
Aug. 2, 2023 (TW) 112129024

(51) Int. Cl. G06V 20/52; G06V 10/25

(52) U.S. Cl. CPC G06V 20/52; G06V 10/25; G06V 2201/07

(57) ABSTRACT

An automatic rule setting method is applied to an image content analysis apparatus. The image content analysis apparatus includes an operation processor and an image receiver. The image receiver is adapted to receive a surveillance image. The operation processor executes the automatic rule setting method. The automatic rule setting method includes analyzing the surveillance image to acquire a scene datum, determining whether the scene datum conforms to a detection rule in accordance with a predefined condition, and automatically drawing a detection boundary of the detection rule on a target region of the surveillance image corresponding to the scene datum when the scene datum conforms to the detection rule, so as to utilize the detection boundary to acquire an object behavior parameter relevant to the detection boundary.

### BACKGROUND OF THE INVENTION

### 1. Field of the Invention

The present invention relates to an automatic rule setting method and an image content analysis apparatus, and more particularly, to an automatic rule setting method of increasing rule-setting convenience and a related image content analysis apparatus.

### 2. Description of the Prior Art

Conventional surveillance image analysis technology requires pre-setting of the detection rule, such as line crossing detection, illegal parking detection, vehicle counting, and/or restricted area loitering detection. Regardless of whether the surveillance image is analyzed in real time or non-real-time, the detection rule is set by the user manually selecting a type of the detection rule and then manually drawing a condition of the selected detection rule on the surveillance image. For example, when the user sets the line crossing detection, the user must manually draw the detection segment on the image; when the user sets the illegal parking detection, the user must manually draw the detection region on the image. However, a position and a length of the detection segment and a position and a size of the detection region are manually set and marked by the user, so the detection rule setting method of the conventional surveillance image analysis technology is inconvenient, and may have the inaccurate analysis result when the user cannot correctly and stably draw the detection segment or the detection region.

### SUMMARY OF THE INVENTION

The present invention provides an automatic rule setting method of increasing rule-setting convenience and a related image content analysis apparatus for solving above drawbacks.

According to the claimed invention, an automatic rule setting method is applied to an image content analysis apparatus. The image content analysis apparatus has an operation processor and an image receiver, and the image receiver is adapted to receive a surveillance image. The automatic rule setting method includes analyzing the surveillance image to acquire a scene datum, determining whether the scene datum conforms to a detection rule in accordance with a predefined condition, and automatically setting a detection boundary of the detection rule on a target region of the surveillance image corresponding to the scene datum when the scene datum conforms to the detection rule, so as to utilize the detection boundary to acquire an object behavior parameter relevant to the detection boundary.

According to the claimed invention, an image content analysis apparatus includes an operation processor adapted to receive a surveillance image acquired by an image receiver, analyze the surveillance image to acquire a scene datum, determine whether the scene datum conforms to a detection rule in accordance with a predefined condition, and automatically set a detection boundary of the detection rule on a target region of the surveillance image corresponding to the scene datum when the scene datum conforms to the detection rule, so as to utilize the detection boundary to acquire an object behavior parameter relevant to the detection boundary.

The automatic rule setting method and the image content analysis apparatus of the present invention can analyze the surveillance image based on the predefined condition. The predefined condition can be the position datum relevant to the surveillance image, the scene similarity parameter relevant to the scene datum, the user's input command, or the cluster learning result of the input command. The present invention can utilize analysis of the predefined condition and the scene datum to automatically and accurately determine the detection rule suitable for the surveillance image, and the parameter type of the detection boundary. Comparing to the prior art, the automatic rule setting method and the image content analysis apparatus of the present invention can significantly reduce the user's involvement in the selection of the detection rule and the setting of the detection boundary, and can autonomously learn, set and calibrate the detection rule and the detection boundary with little or without the user's input command, so as to simultaneously increase the speed, the accuracy and the convenience of the automatic rule setting method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 3 are functional block diagrams of an image content analysis apparatus according to different embodiments of the present invention.

FIG. 4 is a flow chart of the automatic rule setting method according to the embodiment of the present invention.

FIG. 5 is a diagram of the surveillance image captured in an application scenario according to the embodiment of the present invention.

### DETAILED DESCRIPTION

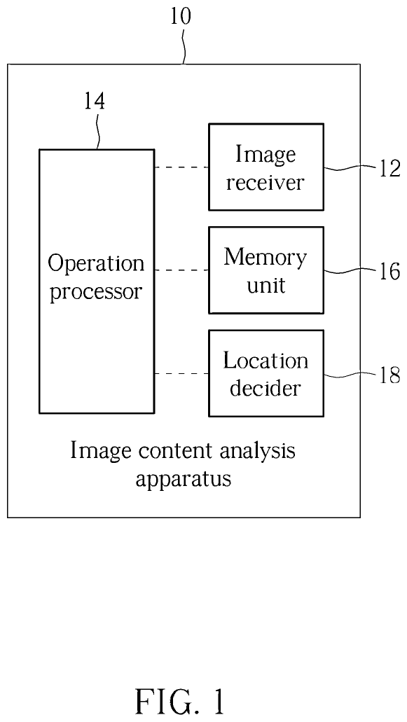

Please refer to FIG. 1 to FIG. 3. FIG. 1 to FIG. 3 are functional block diagrams of an image content analysis apparatus 10 according to different embodiments of the present invention. The image content analysis apparatus 10 can be installed inside a surveillance camera, or can be applied to a cloud server, a network video recorder, a file storage device, a personal computer or a smart phone, which depends on a design demand. The image content analysis apparatus 10 can optionally include an image receiver 12 and at least include an operation processor 14. The image receiver 12 can acquire one surveillance image, or can acquire a surveillance video that contains a plurality of surveillance images generated in sequence. The operation processor 14 can be electrically connected to the image receiver 12 in a wire manner or in a wireless manner, and can execute an automatic rule setting method of the present invention via the surveillance image.

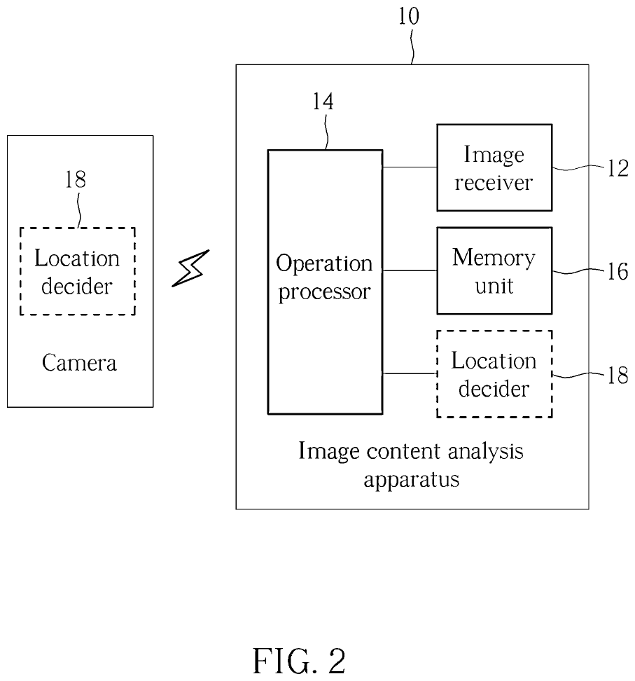

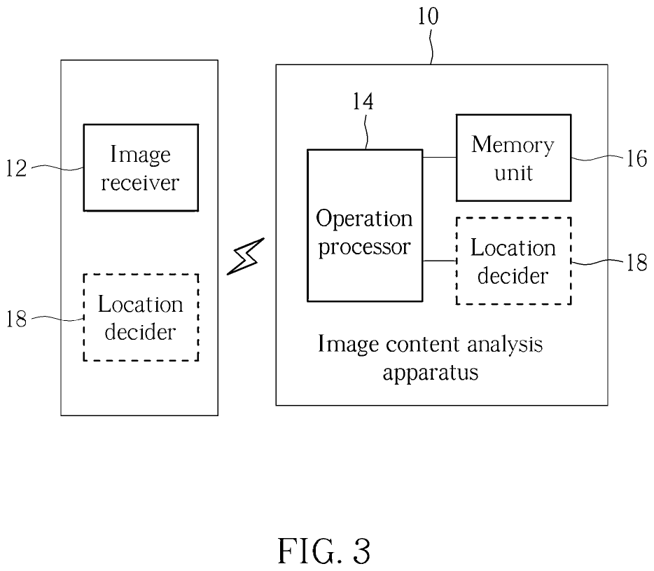

As shown in FIG. 1, when the image content analysis apparatus 10 is installed inside the surveillance camera, the image receiver 12 can be a capture unit of the surveillance camera, and the operation processor 14 can be a built-in processing unit of the surveillance camera or a remote processing unit out of the surveillance camera. As shown in FIG. 2, when the image content analysis apparatus 10 is applied to an external apparatus, such as the cloud server, separated from the surveillance camera, the image receiver 12 can be a wire transmission unit or a wireless transmission unit used to receive the surveillance image generated by the surveillance camera and then transmit the surveillance image to the operation processor 14 for execution of the automatic rule setting method. As shown in FIG. 3, the image content analysis apparatus 10 may be further applied to the external apparatus, such as the network video recorder or the file storage device, and the image receiver 12 can receive the surveillance image from the surveillance camera and then transmit the surveillance image to the operation processor 14 for execution of the automatic rule setting method. Therefore, the automatic rule setting method of the present invention can directly execute image capture and analyze process on the surveillance camera for acquiring an analysis result; or, the automatic rule setting method can utilize the back-end image analysis device to execute the analysis process based on the received surveillance image for acquiring the analysis result; or, the automatic rule setting method can utilize the front-end surveillance camera and the back-end image analysis device to cooperate the image capture and analyze process.

The image content analysis apparatus 10 can analyze a scene datum of the surveillance image, and detect a detection rule possibly appeared in the surveillance image in accordance with the scene datum and a predefined condition, and optionally display the detection rule on the surveillance image for being operated by the user. The detection rule can be generated by a predefined algorithm or a pre-learning algorithm; the foresaid algorithm can be deep learning technology using neural networks, machine learning technology, or various learning technology for recording relevant parameters. Any algorithm that can adjust images or the detection rule in the images can conform to a design demand of the present invention. When the image content analysis apparatus 10 computes multiple detection rules that can be presented in the surveillance image, the image content analysis apparatus 10 can further compute a reasonable probability value of each detection rule. The detection rule which has the reasonable probability value exceeds a predefined threshold value can be used to automatically generate a detection boundary on the surveillance image; or the detection rule may be manually confirmed by the user.

The detection rule that is selected by system or manually by the user can be used to adjust parameters of the detection boundary in accordance with a user's demand. The image content analysis apparatus 10 can store the adjusted parameters for following analysis and learning process. In the present invention, the detection rule that is selected by system or manually by the user can be displayed on the surveillance image by different colors or symbols, and the detection rule that is not selected can be automatically removed by the image content analysis apparatus 10 or manually removed by the user. If the detection rule that the user wants to select is not set in the surveillance image by the image content analysis apparatus 10, the user can manually set the required detection rule. It should be mentioned that all selection and adjustment of the detection rule can be stored by the system for the following analysis and learning process, and a detailed description can be described in the subsequent paragraphs.

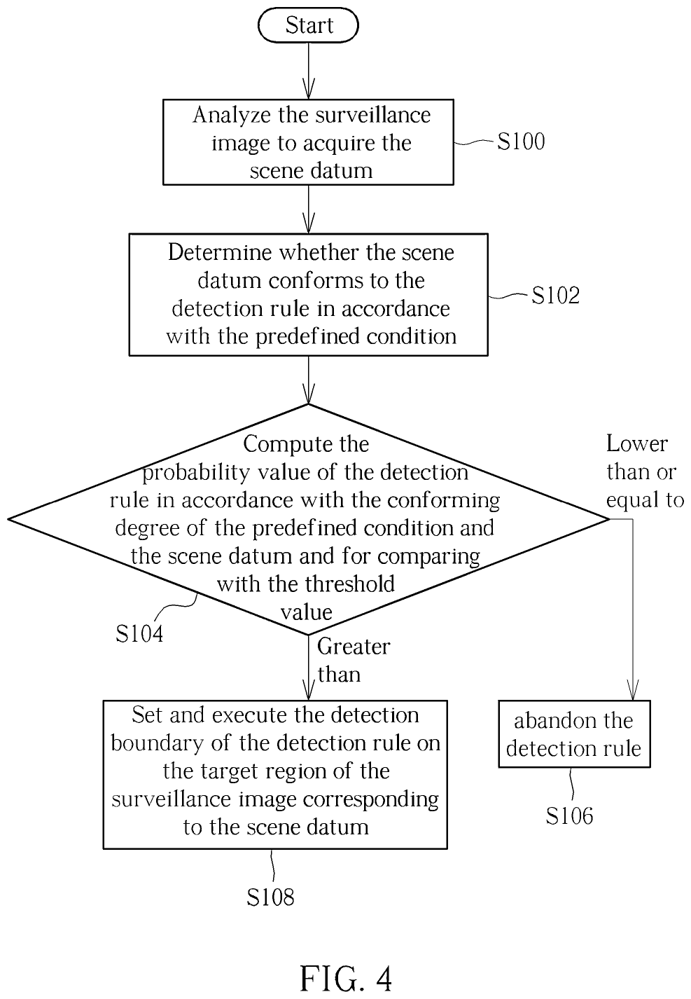

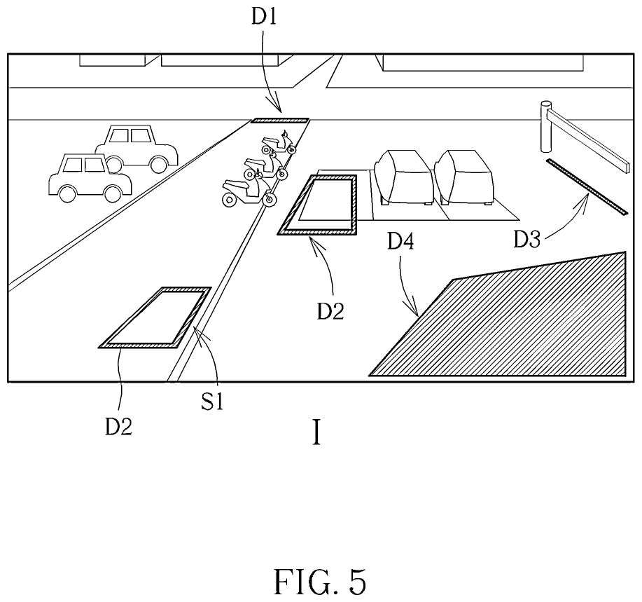

Please refer to FIG. 1 to FIG. 5. FIG. 4 is a flow chart of the automatic rule setting method according to the embodiment of the present invention. FIG. 5 is a diagram of the surveillance image I captured in an application scenario according to the embodiment of the present invention. Regarding the automatic rule setting method, step S100 can be executed to analyze the surveillance image I for acquiring the scene datum. The surveillance camera matched with the image content analysis apparatus 10 may be installed at the intersection, the roadside, the parking lot, or any environment with surveillance needs, and image analysis technology can be used to determine the environment where on the image content analysis apparatus 10 is located. The present invention can preset multiple possible scene data and store the multiple possible scene data into a memory unit 16 of the image content analysis apparatus 10, and the scene datum of the surveillance image I can be determined by feature extraction and identification technology. Besides, the image content analysis apparatus 10 can further utilize the machine learning technology and the deep learning technology to identify content of the scene datum, and practical application of identifying the scene datum can depend on the design demand. As shown in FIG. 5, step S100 can find out the intersection, the roadside, and the parking lot inside the surveillance image I.

Then, step S102 can be executed to determine whether the scene datum conforms to the detection rule in accordance with the predefined condition. The predefined condition can be designed to increase identification accuracy of the scene datum, so that step S102 can generate the detection rule preferably suitable for the scene datum. In the embodiment of the present invention, the predefined condition can be defined as a position datum, and a type of the predefined condition is not limited to the foresaid embodiment. The position datum that is set as the predefined condition can help the image content analysis apparatus 10 to correctly determine the environment in which it is located, and can be used to exclude scenes that are unlikely to appear in this environment and therefore obtain the correct scene datum; the appropriate detection rule can be set only by correctly determining content of the surveillance image I. That is to say, the automatic rule setting method of the present invention can determine one or multiple detection rules conforming to or being suitable for the scene datum in accordance with the scene datum of the surveillance image I and the predefined condition (such as the position datum); for example, as the scene datum shown in FIG. 5, the detection rule can include, but not be limited to, line crossing detection D1 applied for the intersection, illegal parking detection D2 applied for the roadside or the parking lot, vehicle counting D3 and restricted area loitering detection D4 applied for the parking lot.

Then, step S102 can be optionally applied by a learning function Y=F (X). An input parameter X can be the surveillance image or the surveillance video to be analyzed. A function D can be a conversion rule of the predefined condition. An output parameter Y can be a rule category, a parameter type, position coordinates of the detection rule, or a relevant code associated with the detection rule. The present invention can further utilize other manners to analyze the predefined condition and the scene datum to find the consistent and applicable detection rule; the actual application of the learning function is not limited to the foresaid embodiment.

The line crossing detection D1 can indicate that the scene datum contains the intersection of the road and alley. The line crossing detection D1 can be marked at the intersection of different roads, and used to determine whether a vehicle illegally moves from the alley into the road; its parameter type can be a segment pointed by the symbol D1. The illegal parking detection D2 can indicate that the scene datum contains multiple parking space, and the illegal parking detection D2 can be marked at some of the multiple parking space that belongs to the private parking space, or marked at a no parking range excluding the multiple parking space; its parameter type can be a region pointed by the symbol D2. The vehicle counting D3 can indicate the parking lot in the scene datum, and the vehicle counting D3 can be marked at an entrance of the parking lot for counting a traffic flow; its parameter type can be the segment pointed by the symbol D3. The restricted area loitering detection D4 can indicate the parking space in the scene datum, and the restricted area loitering detection D4 can be marked at an aisle of the parking space to avoid the vehicle from illegally parking at the aisle and effecting other vehicle entering and exiting the parking space; its parameter type can be the region pointed by the symbol D4.

The rule category (which includes the line crossing detection D1, the illegal parking detection D2, the vehicle counting D3 and the restricted area loitering detection D4) and the parameter type (which means the segment D1/D3 and the region D2/D4) of the detection rule are only used to illustrate the automatic rule setting method of the present invention, and is not limited to the above-mentioned embodiment and may have various changes. For example, the entrance of the public transport carriage can be set by people flow detection whose parameter type belongs to the segment; the department store and other areas with a large flow of people can be set by loitering detection whose parameter type belongs to the region; scenic area and other areas with a lot of traffic can be set by crowd detection whose parameter type belongs to the region; areas with less flow of people or vehicles can be set by intrusion detection whose parameter type belongs to the region; the front of checkout counter can be set by queue detection whose parameter type belongs to the region. Parameters of the segment detection can include starting point coordinates, end point coordinates, and coordinates on a line between the starting point coordinates and the end point coordinates, and can be used to determine a direction and a number of the line crossing. Parameters of the region detection can include coordinates of each corner point of the region, and coordinates on the lines between the corner points, and can be used to determine a stay period and a number of loitering objects, and further to determine a direction of entering and exiting the region.

Then, step S104 can be executed to compute a probability value of the detection rule in accordance with a conforming degree of the predefined condition and the scene datum and further compare the probability value with the threshold value. Step S102 may select the multiple detection rules, but not all the selected detection rules can be applicable to the scene datum analyzed by the surveillance image I; so the automatic rule setting method of the present invention can utilize step S104 to automatically find out one or some suitable detection rules from the selected detection rules, and decide what detection rule can be applied for the scene datum analyzed by the surveillance image I. As shown in FIG. 5, a lower right part of the surveillance image I can belong to an area with less traffic flow, step S102 may decide the scene datum conforming to the detection rule about the intrusion detection (which is not marked in the figures) and the restricted area loitering detection D4; step S104 can compute the probability value of the intrusion detection and the restricted area loitering detection D4 respectively. When the predefined condition (such as the position datum) indicates that the surveillance image is captured by the surveillance camera installed on the city, step S104 can have a conclusion of the intrusion detection with the lower probability value and the restricted area loitering detection D4 with the high probability value.

The threshold value can be a system default value or set by the user. The system default value can be computed by the machine learning technology and the deep learning technology, or can be analyzed and calibrated according to previous user setting values. In addition, the user can set the threshold value based on experience, or can calibrate the threshold value with a preset adjustment ratio based on the previously user setting value. Practical application of the threshold value can depend on the design demand. When the probability value is lower than or equal to the threshold value, the detection rule may be misjudged or unsuitable, and step S106 can be executed to abandon the detection rule (such as the intrusion detection) without drawing and execution of the detection boundary. When the probability value is greater than the threshold value, the detection rule can be suitable for the scene datum, and step S108 can be executed to automatically set and execute the detection boundary of the detection rule on the target region of the surveillance image I corresponding to the scene datum; as shown in FIG. 5, the restricted area loitering detection D4 can be set on the lower right part of the surveillance image I. Therefore, the automatic rule setting method of the present invention can utilize the detection boundary (which means the restricted area loitering detection D4) to acquire an object behavior parameter relevant to the detection boundary, such as the stay period, and the direction and the number of line crossing, and may further execute object identification operation (such as license plate identification) to acquire information of the object for setting as important information of alarm or record.

Step S102 can utilize the predefined condition to determine the conforming degree of the scene datum and the detection rule, and the predefined condition may come from various possible sources, such as the position datum, a cluster result, a regional feature, and the user setting value. In the possible embodiment of the present invention, when the image content analysis apparatus 10 is installed inside the surveillance camera, the image content analysis apparatus 10 can further include a location decider 18 electrically connected to the operation processor 14. The location decider 18 can acquire the position datum relevant to position of the surveillance camera and the surveillance image captured by the surveillance camera. When the image content analysis apparatus 10 is applied for the external apparatus, such as the cloud server or the file storage device, the location decider 18 can be used to acquire the position datum relevant to the surveillance image generated by the external surveillance camera. The location decider 18 can be a global positioning system of automatically providing the accurate position datum; or, the location decider 18 can be a signal receiver used to receive the position datum provided by the external positioning system; or, the location decider 18 can be an input interface, and the user can manually input the position datum via the input interface. Practical application of the location decider 18 is not limited to the foresaid embodiments, and depends on the design demand.

The position datum provided by the location decider 18 can be set as the predefined condition in step S102. The automatic rule setting method of the present invention can acquire and analyze the scene datum of the surveillance image I; although the image content analysis apparatus 10 may be located on the roadside or the parking lot, environments around the roadsides and the parking lots may be similar and difficult to identify the correct location, so that the image content analysis apparatus 10 can utilize the position datum as the predefined condition to analyze relevance of the position datum and the scene datum, and further compute the probability value of one or the multiple detection rules for acquiring the conforming degree suitable for the scene datum, so as to ensure which detection rule can be applied for the scene datum of the surveillance image I and further to automatically set the detection boundary of the suitable detection rule. As mentioned above, after the detection boundary of the detection rule is automatically set, the user can still manually adjust the detection rule, such as changing a length or a position of the segment of the detection boundary, or changing a size or a position of the region of the detection boundary, or newly-adding or removing the detection boundary of the detection rule. In the possible embodiment of the present invention, the detection boundary can be a line, or a regular region or an irregular region formed by several lines.

In other possible embodiment of the present invention, the memory unit 16 of the image content analysis apparatus 10 can be electrically connected with the operation processor 14 and used to store a scene similarity parameter relevant to the scene datum for being the predefined condition. The scene similarity parameter can be used to identify the regional features, such as the scene similarity parameters for identifying the indoor environment and the outdoor environment, or the scene similarity parameters for identifying the parking lot and the roadside. The automatic rule setting method of the present invention can extract a specific feature vector of the scene datum in the surveillance image I, and execute cluster learning operation on the specific feature vector and the scene similarity parameter, for determining a possible environment of the scene datum and acquiring the conforming degree of one or the multiple detection rules, so as to find out the detection rule suitable for the scene datum and automatically set the detection boundary.

In the embodiment, the user can utilize the input interface of the image content analysis apparatus 10 to manually set the scene similarity parameter; for example, the user may watch the surveillance image I and manually set a kind of the scene. Moreover, the image content analysis apparatus 10 can analyze a large number of the surveillance images I and find out the specific feature vector to execute the cluster learning operation. The analysis result of the cluster learning operation can be the scene similarity parameter setting as the predefined condition. After the new surveillance image I is acquired, the present invention can determine what possible environment the current surveillance image I may belong to, in accordance with the analysis result of the previous surveillance image I (which means the scene similarity parameter), and then find out the detection rule that has the conforming degree suitable for the scene datum (which means the probability value of the detection rule may exceed the threshold value). In the embodiment, the image content analysis apparatus 10 can analyze the scene similarity parameter manually set by the user to calibrate the scene similarity parameter automatically set by the cluster learning operation; the user can reference the scene similarity parameter automatically set by the cluster learning operation, or can manually calibrate the scene similarity parameter in accordance with an actual situation. Practical application of the scene similarity parameter is not limited to the foresaid embodiment, and depends on the design demand.

In addition, the automatic rule setting method of the present invention can further automatically analyze the line that appears in the scene datum and is regarded as the detection boundary, and serve the line as a basis of setting the detection boundary. For example, the automatic rule setting method of the present invention can automatically analyze the line of the roadside S1 within the scene datum shown in FIG. 4, and combine the line and other data (for example, the embodiment may have, but not be limited to, situations of whether a red line is marked on the roadside S1, or whether a fire hydrant is set on the roadside S1, or another roadside, or a width of the road, or a moving vehicle or a stationary vehicle) to determine whether the line can be the roadside S1 and the related detection rule, and then utilize the roadside S1 to automatically set position of the detection boundary of the related detection rule; for example, a long side of the illegal parking detection D2 may be adjacent to or overlapped with the roadside S1, so as to achieve the optimal detection boundary consistent with the actual scene and further to increase setting accuracy of the detection boundary. In addition to the foresaid embodiment in combination with other data, other data may be other regulation complying with local traffic rules; for example, no parking on the red line or within 10 meters of the road corner or the mesh lines can be used as reference for automatically analyzing the scene datum by the automatic rule setting method. Besides, the detection boundary is not limited to lines of the regional boundary, and can be the line-type boundary with an irregular shape analyzed by the actual scene.

Based on the foresaid possible embodiments, the user can use the input interface of the image content analysis apparatus 10 to generate an input command for adjusting the detection boundary of the detection rule in different situations; the adjusted detection boundary can be stored in the memory unit 16 for optionally being the predefined condition. The memory unit 16 can be a built-in unit of the image content analysis apparatus 10, or can be an external unit of the back-end system. Take an example shown in FIG. 5, the automatic rule setting method of the present invention can automatically set the line crossing detection D1 on the target region (an upper left part of the frame) of the surveillance image I after analysis of the surveillance image I, but the user may consider that the segment of the detection boundary related to the line crossing detection D1 is not perfectly matched with the boundary of the actual scene, and can manually adjust the detection boundary (for example, adjusting the position, the length or the angle of the detection boundary) because the line crossing detection D1 cannot cover a width of the road; then, when the automatic rule setting method further acquires the similar or the same scene datum on the surveillance image I to set the line crossing detection D1, the adjusted detection boundary by manual setting can be directly used as the detection boundary of the line crossing detection D1 and be automatically set within the surveillance image I, or the detection boundary of the original segment by automatically setting can be calibrated (for example, a mean value of the adjusted detection boundary and the original detection boundary by automatically setting can be computed as a new detection boundary) based on the adjusted detection boundary by manual setting, for automatically setting the new detection boundary.

If the user manually adjust the detection boundary, the user may consider that the scene datum analyzed by the surveillance image I conforms to the actual environment and the detection rule conforms to the actual demand, but the detection boundary may be a little different from the actual situation and in need of calibration, so that the conforming degree of the detection rule can be optionally increased in accordance with the adjusted detection boundary and the scene datum for calibrating the probability value of the detection rule. In the following analysis of the surveillance image I, the present invention can rapidly confirm the scene datum suitable for what detection rule when the relevant scene datum is acquired in the same or similar predefined condition, for automatically setting of the detection boundary.

It should be mentioned that the input command of the user can be stored into the memory unit 16 together with the scene datum and the predefined condition for autonomous learning operation, in accordance with a selection result of the detection rule and an adjustment result of the detection boundary; the learning server set in the memory unit 16 or the cloud device can further classify the plurality of input commands of all users, such as executing the cluster learning operation based on the input commands (and the selection result of the detection rule and the adjustment result of the detection boundary, and the related scene datum and the related predefined condition) of all users, some users, or one user. In the following application of the present invention, the automatic rule setting method can decide selection of the detection rule and setting of the detection boundary based on a learning model set by different cluster learning operation. Besides, even if the input command comes from the same user, the automatic rule setting method of the present invention can execute the cluster learning operation on the input command in accordance with the predefined condition such as the scene similarity parameter and/or the position datum, which means different locations (e.g. the intersection and the parking lot) and different positions (e.g. the urban and the suburban) can respectively have the corresponding selection mode of the detection rule and the corresponding setting mode of the detection boundary.

In conclusion, the automatic rule setting method and the image content analysis apparatus of the present invention can analyze the surveillance image based on the predefined condition. The predefined condition can be the position datum relevant to the surveillance image, the scene similarity parameter relevant to the scene datum, the user's input command, or the cluster learning result of the input command. The present invention can utilize analysis of the predefined condition and the scene datum to automatically and accurately determine the detection rule suitable for the surveillance image, and the parameter type of the detection boundary. Comparing to the prior art, the automatic rule setting method and the image content analysis apparatus of the present invention can significantly reduce the user's involvement in the selection of the detection rule and the setting of the detection boundary, and can autonomously learn, set and calibrate the detection rule and the detection boundary with little or without the user's input command, so as to simultaneously increase the speed, the accuracy and the convenience of the automatic rule setting method.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An automatic rule setting method applied to an image content analysis apparatus, the image content analysis apparatus having an operation processor and an image receiver, the image receiver being adapted to receive a surveillance image, the automatic rule setting method comprising:
the operation processor analyzing the surveillance image to acquire a scene datum;
the operation processor determining whether the scene datum conforms to a detection rule in accordance with a predefined condition; and
the operation processor automatically setting a detection boundary of the detection rule on a target region of the surveillance image corresponding to the scene datum when the scene datum conforms to the detection rule, so as to utilize the detection boundary to acquire an object behavior parameter relevant to the detection boundary.

2. The automatic rule setting method of claim 1, further comprising:
the operation processor computing a probability value of the detection rule in accordance with a conforming degree of the predefined condition and the scene datum; and
the operation processor setting the detection boundary on the target region when the probability value exceeds a threshold value.

3. The automatic rule setting method of claim 1, wherein the image content analysis apparatus further acquires a position datum relevant to the surveillance image for being the predefined condition, the operation processor analyzes relevance of the position datum and the scene datum to acquire a conforming degree of the detection rule.

4. The automatic rule setting method of claim 1, wherein the image content analysis apparatus further has a memory unit electrically connected to the operation processor and adapted to store a scene similarity parameter relevant to the scene datum for being the predefined condition, the operation processor executes cluster learning operation by the scene similarity parameter and the scene datum to acquire a conforming degree of the detection rule.

5. The automatic rule setting method of claim 4, wherein the operation processor sets the scene similarity parameter via an input command, or sets the scene similarity parameter via an analysis result of the surveillance image.

6. The automatic rule setting method of claim 1, wherein the image content analysis apparatus further has a memory unit electrically connected to the operation processor, the operation processor adjusts the detection boundary in accordance with at least one input command, and stores the adjusted detection boundary into the memory unit for optionally being the predefined condition.

7. The automatic rule setting method of claim 6, wherein the operation processor replaces the automatically-setting detection boundary by the adjusted detection boundary, or utilizes the adjusted detection boundary to accordingly adjust the automatically-setting detection boundary.

8. The automatic rule setting method of claim 6, wherein the operation processor analyzes the adjusted detection boundary and the scene datum to acquire a conforming degree of the detection rule.

9. The automatic rule setting method of claim 6, wherein the operation processor adjusts the detection boundary via a plurality of input commands, and executes cluster learning operation by the adjusted detection boundary and the scene datum to acquire a conforming degree of the detection rule.

10. An image content analysis apparatus, comprising:
an operation processor adapted to receive a surveillance image acquired by an image receiver, analyze the surveillance image to acquire a scene datum, determine whether the scene datum conforms to a detection rule in accordance with a predefined condition, and automatically set a detection boundary of the detection rule on a target region of the surveillance image corresponding to the scene datum when the scene datum conforms to the detection rule, so as to utilize the detection boundary to acquire an object behavior parameter relevant to the detection boundary.

11. The image content analysis apparatus of claim 10, wherein the operation processor is adapted to further compute a probability value of the detection rule in accordance with a conforming degree of the predefined condition and the scene datum, and set the detection boundary on the target region when the probability value exceeds a threshold value.

12. The image content analysis apparatus of claim 10, wherein the image content analysis apparatus further acquires a position datum relevant to the surveillance image for being the predefined condition, and the operation processor is adapted to further analyze relevance of the position datum and the scene datum to acquire a conforming degree of the detection rule.

13. The image content analysis apparatus of claim 10, wherein the image content analysis apparatus further has a memory unit electrically connected to the operation processor and adapted to store a scene similarity parameter relevant to the scene datum for being the predefined condition, the operation processor is adapted to further execute cluster learning operation by the scene similarity parameter and the scene datum to acquire a conforming degree of the detection rule.

14. The image content analysis apparatus of claim 13, wherein the operation processor is adapted to further set the scene similarity parameter via an input command, or set the scene similarity parameter via an analysis result of the surveillance image.

15. The image content analysis apparatus of claim 10, wherein the image content analysis apparatus further has a memory unit electrically connected to the operation processor, and the operation processor is adapted to further adjust the detection boundary in accordance with at least one input command, and store the adjusted detection boundary into the memory unit for optionally being the predefined condition.

16. The image content analysis apparatus of claim 15, wherein the operation processor is adapted to further replace the automatically-setting detection boundary by the adjusted detection boundary, or utilize the adjusted detection boundary to accordingly adjust the automatically-setting detection boundary.

17. The image content analysis apparatus of claim 15, wherein the operation processor is adapted to further analyze the adjusted detection boundary and the scene datum for acquiring a conforming degree of the detection rule.

18. The image content analysis apparatus of claim 15, wherein the operation processor is adapted to further adjust the detection boundary via a plurality of input commands, and execute cluster learning operation by the adjusted detection boundary and the scene datum for acquiring a conforming degree of the detection rule.
